(19) United States
(12) Patent Application Publication
(10) Pub. No.: US 2004/0021630 A1
(43) Pub. Date: Feb. 5, 2004

(54) LCD apparatus and back light module thereof

(76) Inventors: Jen-Cheng Lai, Taoyuan (TW); Chin-Kai Sun, Taipei (TW)

Correspondence Address: Michael D. Bednarek, Shaw Pittman LLP, 1650 Tysons Boulevard, McLean, VA, 22102, US

(21) Appl. No.: 10/621,322

(22) Filed: Jul. 18, 2003

(30) Foreign Application Priority Data
Jul. 31, 2002 (TW) 91211707

(51) Int. Cl. G09G 3/36

(52) U.S. Cl. 345/102

(57) ABSTRACT

The present invention discloses a LCD apparatus and a back light module thereof. The back light module and a printed circuit board are disposed within a housing having a depression. The back light module includes a back light plate and light source disposed on the printed circuit board. The back light plate and the housing are formed in integral. The back light plate includes a plurality of holes allowing passage of the light generated by the light source.

This application claims priority of Taiwan Patent Application No.091211707 filed Jul. 31, 2002.

### FIELD OF INVENTION

The present invention relates to a liquid crystal display (LCD) apparatus and back light module thereof for use with a portable electronic apparatus.

### BACKGROUND OF THE INVENTION

FIG. 1 shows an embodiment of the liquid crystal display (LCD) apparatus of the prior art. As FIG. 1 shows, the LCD apparatus includes an LCD module 108 and a back light module, which includes a back light plate 110 and a light source 114 disposed on a printed circuit board 112. After being reflected by the back light plate 110, a light generated by the light source 114 transforms into a uniform light, which is provided as a backlight of the LCD module 108. The LCD module 108, an upper housing 104 and a cover panel 102 are disposed over the back light plate 110. A foam polymer 106 is disposed between the LCD module 108 and the cover panel 102 to support the cover panel 102. In addition, the foam polymer 106 is used to disperse an external force exerted on the cover panel 102 and prevent the LCD module 108 from cracking.

FIG. 2 shows the assembled LCD apparatus shown in FIG. 1. The upper housing 104 and the cover panel 102 are hidden to clearly show the corresponding relation between the LCD module 108 and the back light plate 110. The light source 114 is disposed on a side of the back light plate 110, and the LCD module 108 is disposed over the back light plate 110. After being reflected by the back light plate 110, a light generated by the light source 114 forms the backlight of the LCD module 108.

FIG. 3 shows a profile of the embodiment shown in FIG. 2. The foam polymer 106 is the only element disposed between the LCD module 108 and the cover panel 102. When an external force is exerted on the cover panel, the external force may be transmitted to the LCD module 108, and then cause the LCD module 108 to crack. To prevent this situation, the thickness of the foam polymer 106 has to be increased to disperse the external force.

### SUMMARY OF THE INVENTION

It is an aspect of the present invention to provide a liquid crystal display (LCD) apparatus and a back light module thereof for use with a portable electronic apparatus.

In a preferred embodiment, the back light module is disposed within a housing of the electronic apparatus. The electronic apparatus includes a printed circuit board. The back light module includes a back light plate and a light source, which is disposed on the printed circuit board. The back light plate and the housing are formed in integral. The back light plate includes a plurality of holes allowing the passage of the light generated by the light source.

In another embodiment, the LCD apparatus includes an upper housing, which has a depression. The back light plate is disposed under the depression. The back light plate has a first surface and second surface. An LCD module is disposed on the second surface. The first surface includes a light-reflecting film. A printed circuit board is disposed under the light-reflecting film. A light source is disposed on the printed circuit board. A cover panel is disposed over the LCD module and covers the depression. While an external force is exerted on the cover panel, the upper housing and the back light plate are capable of dispersing the external force and prevent the LCD module from cracking.

This and other aspects of the present invention will become clear to those of ordinary skills in the art after having read the following detailed description of the preferred embodiments illustrated in the various figures and drawings.

### BRIEF DESCRIPTION OF THE DRAWINGS

FIG. 1 shows an explosive view of a liquid crystal display apparatus of the prior art;

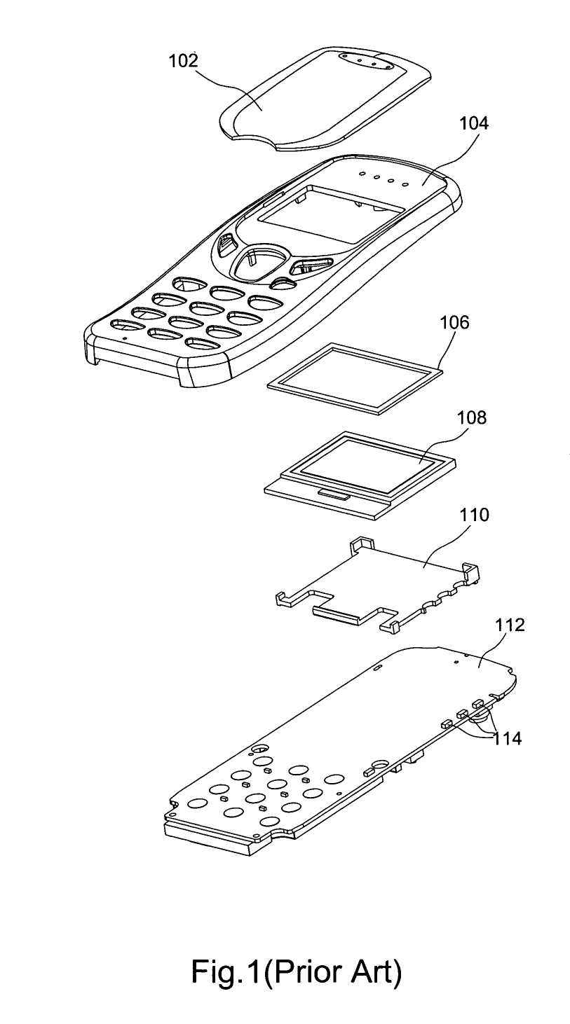

FIG. 2 shows an embodiment of a liquid crystal display module;

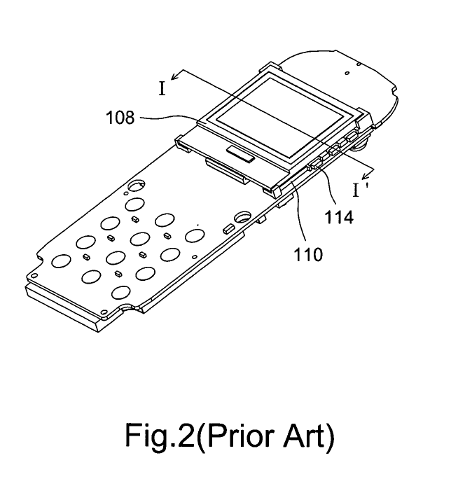

FIG. 3 shows a I-I′ profile of the embodiment shown in FIG. 2;

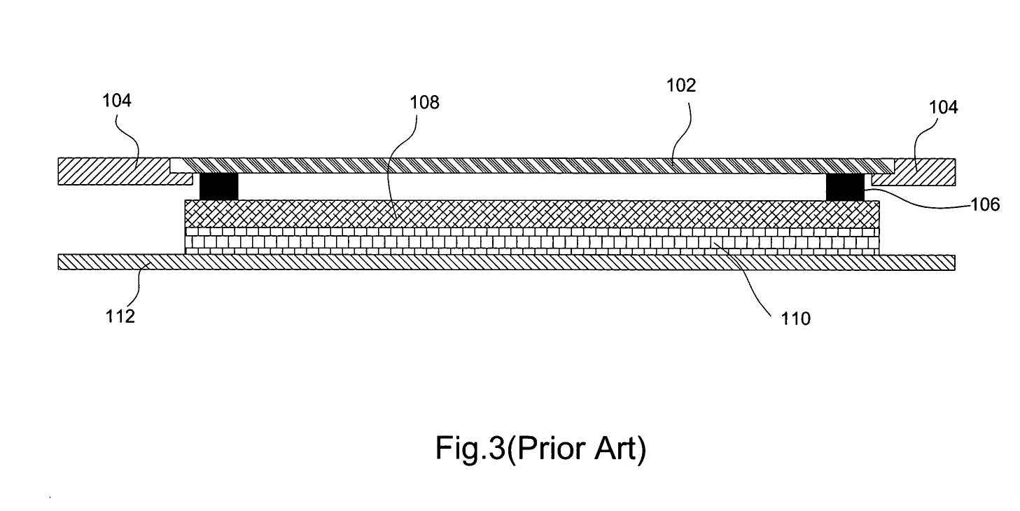

FIG. 4 shows an explosive view of an embodiment of the present invention;

FIG. 5 shows an embodiment of an upper housing and back light plate;

FIG. 6 shows a rear view of the upper housing;

FIG. 7 shows an embodiment of a liquid crystal display module of the present invention; and

FIG. 8 shows a II-II′ profile of the embodiment shown in FIG. 6.

### DETAILED DESCRIPTION

The present invention provides a liquid crystal display (LCD) apparatus and a back light module thereof for use with a portable electronic apparatus. This LCD apparatus has a thinner thickness.

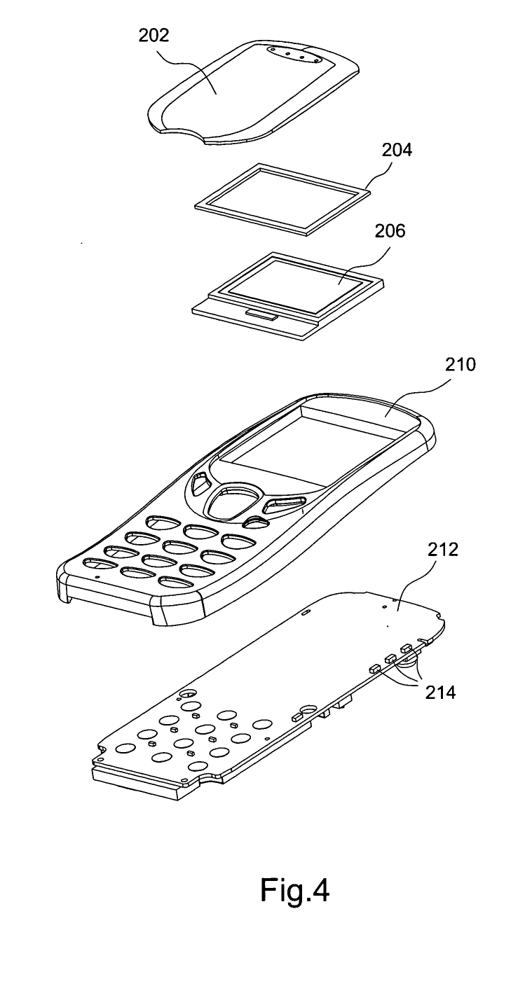

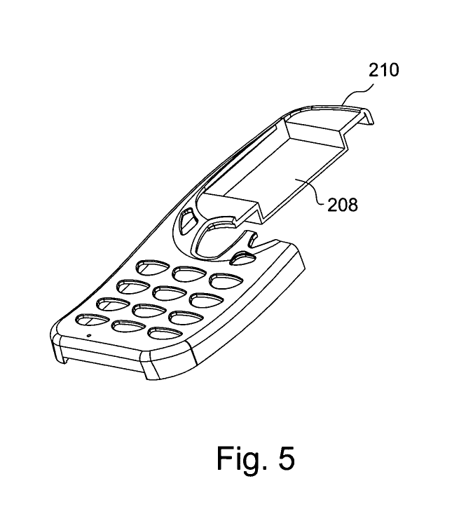

FIG. 4 shows an explosive view of an embodiment of the present invention. In this preferred embodiment, the LCD apparatus is for use with a mobile phone. As FIG. 4 and FIG. 5 show, an LCD module 206 is disposed over the back light plate 208. A cover panel 202 is disposed over the LCD module 206. A foam polymer is selectively disposed between the LCD module 206 and the cover panel 202 to prevent dust from accumulating on the LCD module 206. A light source 214 is disposed on a printed circuit board for generating a light, which is used as a backlight of the LCD module 206. As FIG. 5 shows, the back light plate 208 and the upper housing 210 are formed in integral. In this embodiment, the back light plate 208 and the upper housing 210 are formed by using injection-molding process. The upper housing has a depression, and the LCD module 206 is disposed within the depression.

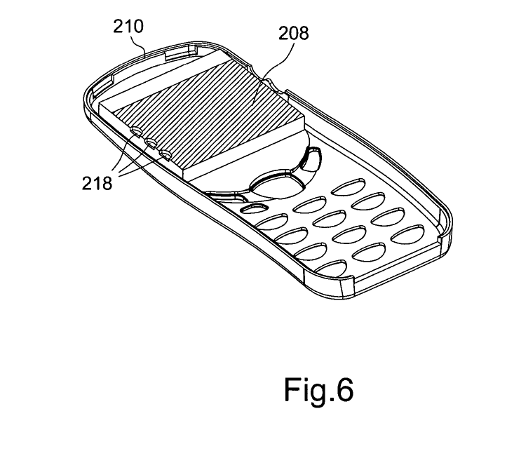

FIG. 6 shows a back view of the upper housing 210 and the back light plate 208. The back light plate 208 includes a plurality of holes 218. The light generated by the light source 214 illuminates the back light plate 208 through the holes 218.

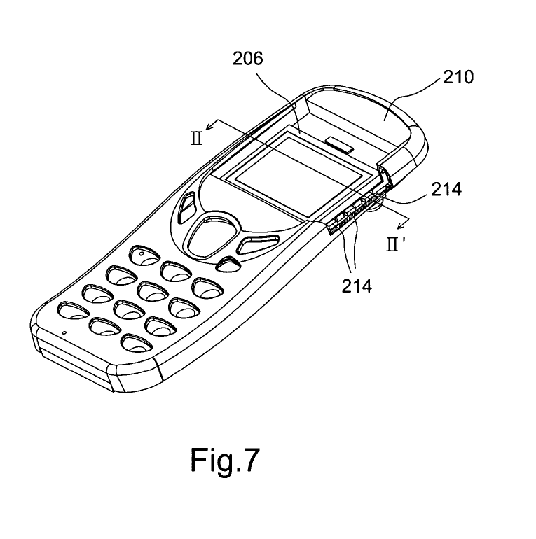

FIG. 7 shows an embodiment of the LCD apparatus. The cover panel is not shown in FIG. 7 to clearly show the corresponding relation between the LCD module 206 and the back light plate 208. As FIG. 6 and FIG. 7 show, the light passes through the holes 218 and illuminates the back light plate 208. After being reflected by the back light plate 208, the light transforms in to a uniform light, which is provided as a backlight of the LCD module 206. In a preferred embodiment, the back light plate 208 includes a plurality of concave surfaces and convex surfaces (not shown), which may help to make the reflected light more uniform.

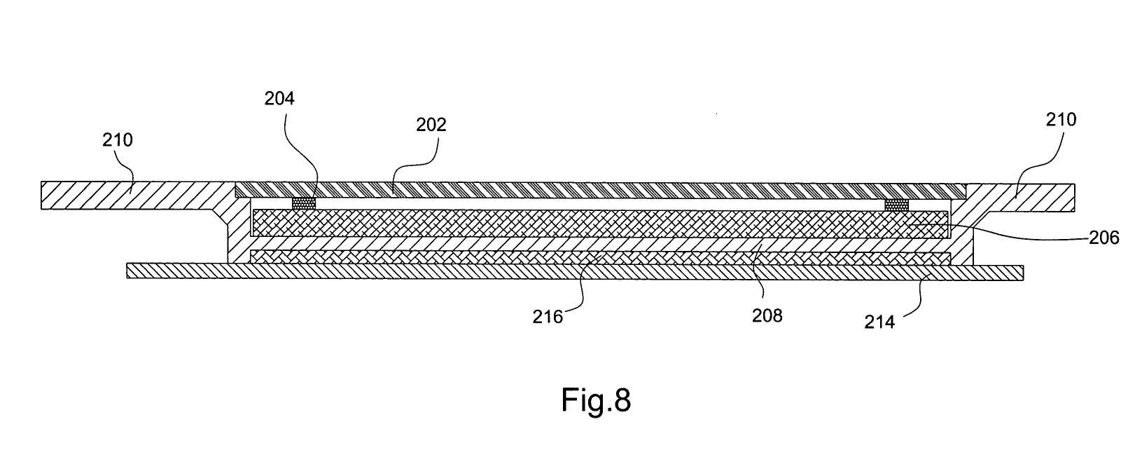

FIG. 8 shows a profile of the embodiment shown in FIG. 7. The back light plate 208 includes a first surface and a second surface. The LCD module 206 is disposed on the second surface. The first surface includes a light-reflecting film 216, which is disposed between the back light plate 208 and the printed circuit board 212 to reflect the light. Therefore the light that illuminates the back light plate 208 may be completely reflected to the LCD module 206. The back light module, including the light source 214, the back light plate 208 and the light-reflecting film 216, is capable of providing the backlight to satisfy the demand of the LCD module 206.

As FIG. 8 shows, the cover panel 202 is disposed over the LCD module 206 and covers the depression. Traditionally, the cover panel 202 is supported by the foam polymer 204. However, in the present invention, different from the traditional skills, the cover panel 202 is supported by the upper housing 210 and back light plate 208. While an external force is exerted on the cover panel 202, the upper housing 210 and the back light plate 208 are capable of dispersing the external force and prevent the LCD module 206 from cracking. The foam polymer 204 in the present invention is merely used to prevent dust from accumulating. Therefore, the thickness of the foam polymer 204 may be reduced to make the entire module thinner.

In the preferred embodiments mentioned above, the portable electronic apparatus may include a mobile phone. However, in other embodiments, the portable electronic apparatus may include a personal digital assistant (PDA), a portable computer, a digital camera, or other similar apparatuses.

Those skilled in the art will readily observe that numerous modifications and alterations of the apparatus may be made within the teaching of the invention. Accordingly, the above disclosure should be construed as limited only by the metes and bounds of the appended claims.

1. A liquid crystal display (LCD) apparatus for use with a portable electronic apparatus, said LCD apparatus including a LCD module and a back light module, said portable electronic apparatus including a printed circuit board and a housing having a depression, said LCD module being disposed within said depression, said back light module comprising:
a back light plate disposed under said depression; and
a light source disposed on said printed circuit board for generating a light;
wherein said back light plate and said housing are formed in integral, and said back light plate includes a plurality of holes allowing passage of the light generated by said light source.

2. The LCD apparatus of claim 1, wherein said back light plate includes a first surface and a second surfaces said first surface includes a light-reflecting film to reflect said light; said LCD module is disposed on said second surface.

3. The LCD apparatus of claim 1, wherein said back light plate includes a plurality of concave surfaces and a plurality of convex surfaces.

4. The LCD apparatus of claim 1, wherein said light source includes a light emitting diode (LED).

5. The LCD apparatus of claim 1, wherein said light source includes a cold cathode lamp.

6. A liquid crystal display (LCD) apparatus, comprising:
an upper housing including a depression;
a back light plate disposed under said depression, said back light plate including a first surface and a second surface;
a printed circuit board disposed under said back light plate;
a light-reflecting film disposed on said first surface and between said back light plate and said printed circuit board;
a LCD module disposed on said second surface;
a light source disposed on said printed circuit board for generating a light; and
a cover panel disposed over said LCD module and covering said depression;
wherein said back light plate and said housing are formed in integral, and said back light plate includes a plurality of holes allowing passage of the light generated by said light source.

7. The LCD apparatus of claim 6, further including a foam polymer disposed between said LCD module and said cover panel to prevent dust from cumulating on said LCD module.

8. The LCD apparatus of claim 6, wherein said back light plate includes a plurality of concave surfaces and a plurality of convex surfaces.

9. The LCD apparatus of claim 6, wherein said light source includes a light emitting diode (LED).

10. The LCD apparatus of claim 6, wherein said light source includes a cold cathode lamp.

11. The LCD apparatus of claim 6, wherein said cover panel is made of a transparent material.

12. The LCD apparatus of claim 11, wherein said transparent material includes a plastic material.

13. The LCD apparatus of claim 11, wherein said transparent material includes a glass material.
